(19) United States
(12) Patent Application Publication
(10) Pub. No.: US 2006/0122954 A1
(43) Pub. Date: Jun. 8, 2006

(54) Medical simulator apparatus and method

(76) Inventors: Robert J. Podlasek, Springfield, IL (US); Arnold Patton, Washington, IL (US)

Correspondence Address: HUSCH & EPPENBERGER, LLC, 190 CARONDELET PLAZA, SUITE 600, ST. LOUIS, MO, 63105-3441, US

(21) Appl. No.: 11/292,619

(22) Filed: Dec. 2, 2005

Related U.S. Application Data
(60) Provisional application No. 60/633,064, filed on Dec. 3, 2004.

(51) Int. Cl. G07F 11/00

(52) U.S. Cl. 706/920; 221/24

(57) ABSTRACT

An animal simulator having electroactive polymer assemblies and a control system connected to the assemblies is disclosed. An animal simulator is constructed and arranged to mimic selected anatomy. It includes a substrate; an electroactive polymer assembly, within the substrate, the electroactive polymer assembly being comprised of at least one electroactive polymer and at least one electrode. A circuit is in operative communication with the electrode such that the electroactive polymer assembly deflects upon receipt of a signal through the circuit. The deflection simulates anatomy. The animal simulator further comprising a sensor, within the simulator, with the sensor being in operative communication with the circuit.

### CROSS-REFERENCE TO RELATED APPLICATIONS

This application claims the benefit of U.S. Provisional Application No. 60/633,064, filed Dec. 3, 2004.

### BACKGROUND OF THE INVENTION

1. Field of the Invention

The present invention relates to medical teaching simulators and, more particularly, to a medical teaching simulator utilizing an electroactive polymer.

2. Related Art

Model-driven simulators (MDS) for medical training, sometimes known as high fidelity simulators, are simulators that use a manikin body or part of a body to physically represent a patient. The simulators have physiologic and pharmacologic models that direct real time autonomous reactions to interventions and therapies. MDS systems generally integrate multiple system models to produce an analogous patient response to interventions, such as surgery or placement of a stent or probe.

MDS systems can be used to teach normal and abnormal physiology and pharmacology, equipment usage, patient and provider safety, resource management, and crisis management. However, current MDS systems generally lack a genuine touch and feel of a real patient. For example, current MDS systems do not exhibit symptoms or reactions in response to stimuli, such as the insertion of a probe or needle. They cannot mimic the feel, reflexes, or tightening of human tissue.

Electroactive polymers are polymers that have characteristics which can be modified by applying electrical energy. U.S. Pat. No. 6,545,384, and U.S. patent application 2005/0006989 A1 which are incorporated by reference herein, disclose electroactive polymers for various electromechanical devices. Specifically, U.S. Pat. No. 6,545,384 discloses pre-strained polymers comprised of insulating polymer or rubber (or combination thereof) that deforms in response to an electrostatic force or whose deformation results in a change in electric field. More generally, exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers also comprising silicone and acrylic moieties, or polymer blends comprising a silicone elastomer and an acrylic elastomer, for example.

There remains a need in the art for a system simulating animals in general and human medical patients in particular, that is more life-like and which exhibits certain characteristics in response to stimuli that mimic the characteristic responses of real tissue in response to the same stimuli.

### SUMMARY OF THE INVENTION

The invention is a simulator having electroactive polymer components and a control system connected to those components. The electroactive polymers (EAPs) have certain characteristics that may be changed with a given electrical input including but not limited to displacement of geometrical dimensions, exertion of mechanical force, elasticity, ductility, density and electrical resistance and capacitance. The control system can statically or dynamically change the electrical input to the EAPs. By matching the characteristics of the electro active polymers to known characteristics of human tissue, a more life-like MDS system is achieved. By controlling the characteristics of the electroactive polymers with the control system, the MDS system will exhibit more life-like responses for a given stimuli.

Further areas of applicability of the present invention will become apparent from the detailed description provided hereinafter including for example without limitation veterinary simulators, toys, animatronics, amusement devices and athletic training devices. It should be understood that the detailed description and specific examples, while indicating the preferred embodiment of the invention, are intended for purposes of illustration only and are not intended to limit the scope of the invention. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of an MDS system;

FIG. 2 is a sectional side view of an embedded electro active polymer;

FIG. 3 is a perspective view of a first embodiment of an electroactive polymer matrix;

FIG. 4 is a top view of a second embodiment of the electroactive polymer matrix;

FIG. 5 is a side view of a third embodiment of the electroactive polymer matrix;

FIG. 6 is a schematic of a control system; and

FIG. 7 is flowchart illustrating the control system.

FIG. 8 is a flowchart for the present invention.

FIG. 9 is a schematic block diagram.

FIG. 10 depicts optional arrays.

FIG. 11 is an exploded view of the components of a medical simulator.

FIG. 12 is a cutaway diagram of the medical simulator.

FIG. 13 is a flowchart.

FIGS. 14A and 14B are EAP assemblies in perspective view.

FIG. 15 is an alternate EAP assembly in side view.

FIG. 16 depicts an artificial muscle array.

### DETAILED DESCRIPTION OF THE PREFERRED EMBODIMENTS

The following description of the preferred embodiment(s) is merely exemplary in nature and is in no way intended to limit the invention, its application, or uses.

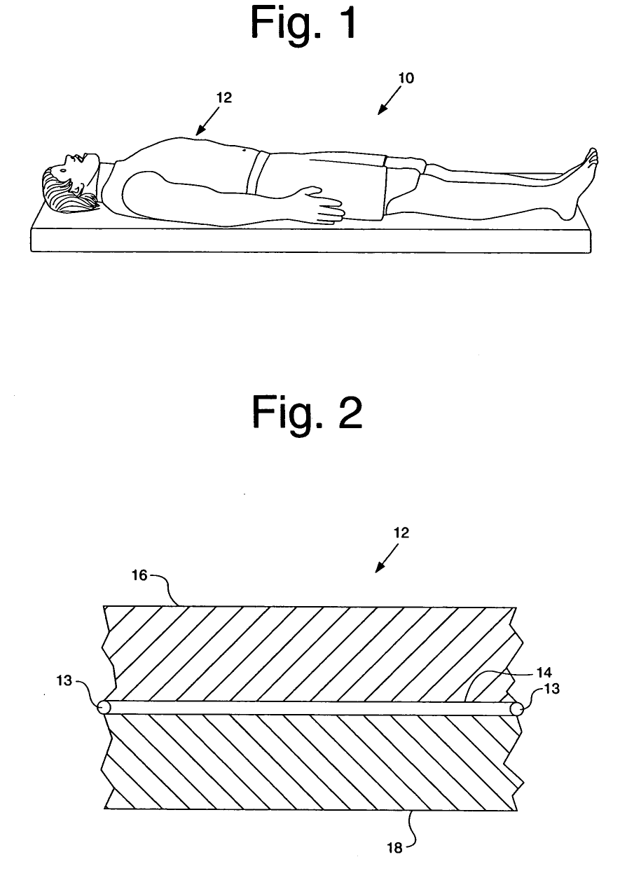

Referring to the accompanying drawings in which like reference numbers indicate like elements, FIG. 1 illustrates an MDS system 10 in the form of a manikin. The MDS system 10 is a full sized manikin that delivers hands on experience of real life scenarios for medical students. Some MDS systems 10 have the ability to blink, speak and breath, have a heart beat and a pulse and accurately mirror human responses to procedures including, without limitation, CPR, intravenous medication, intubation, ventilation and catheterization.

The MDS system 10 includes a polymer layer 12 with an electroactive polymer 14 (best seen in FIGS. 2, 11 and 12) embedded within. As examples, the polymer layer 12 may be in a form of a blood vessel, skin, or an organ. In the depicted embodiment, the EAP is fiber, although EAPs are available in sheets, bands, strips and other configurations.

FIG. 2 illustrates the polymer layer 12 with the embedded fiber 14. There is a first layer 16 of the non-electroactive polymer 12, e.g. latex, the electroactive polymer fiber 14, and a second non-EAP polymer layer 18. The fiber 14 is an electroactive polymer such that its characteristics may be changed when the fiber 14 is subjected to electrical energy. The polymer layer 12 may be such things as plastic, an elastomer, or latex. The fiber 14 may be embedded within the polymer by molding, extrusion, lamination, assembly or protrusion. The electroactive fiber 14 has a length, a modulus of elasticity, a percentage of elongation, a tensile strength and a ductility. EAPs can generally displace by elongation, contraction, bending or otherwise. When activated they may exert mechanical force, torsion and linear or area strain.

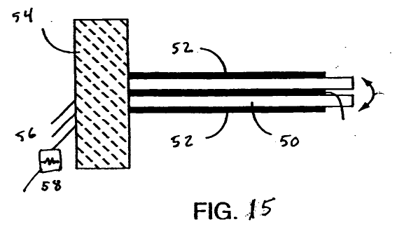

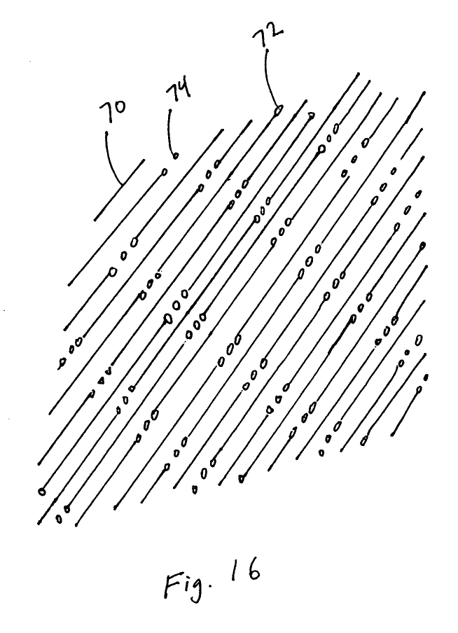

FIGS. 14A and 14B depict an EAP assembly, comprised of an EAP layer 40 and two electrodes 42 and 44. In FIG. 14B, when a current is applied, the EAP 40 displaces to flatten and widen. FIG. 15 depicts an EAP assembly comprising laminated layers of EAPs 50 and electrodes 52 mounted to a base 54 and powered by a circuit connection 56. Such layers or stacks can deflect more, or with greater force. Some EAPs may deflect up to 500% in a given dimension.

By applying a potential difference across an EAP component 14, the properties of the component may be changed. For example, applying a potential difference to the fiber 14 changes the length, tensile strength, modulus of elasticity, the ductility and/or dimensions. Human tissue also has a certain tension, ductility, or modulus elasticity and each organ has its own characteristics with these properties. By adjusting the characteristics of the electroactive fiber 14 within the polymer layer 12 it is possible to mimic the responses of human organs to stimuli.

In the embodiment depicted in FIG. 2, an electrode 13 is attached to each end of the electroactive fiber 14, and the potential difference is applied to the electrodes. The fiber 14 then contracts, similarly to a muscle. The EAP components may be arranged to simulate the movements of various organs.

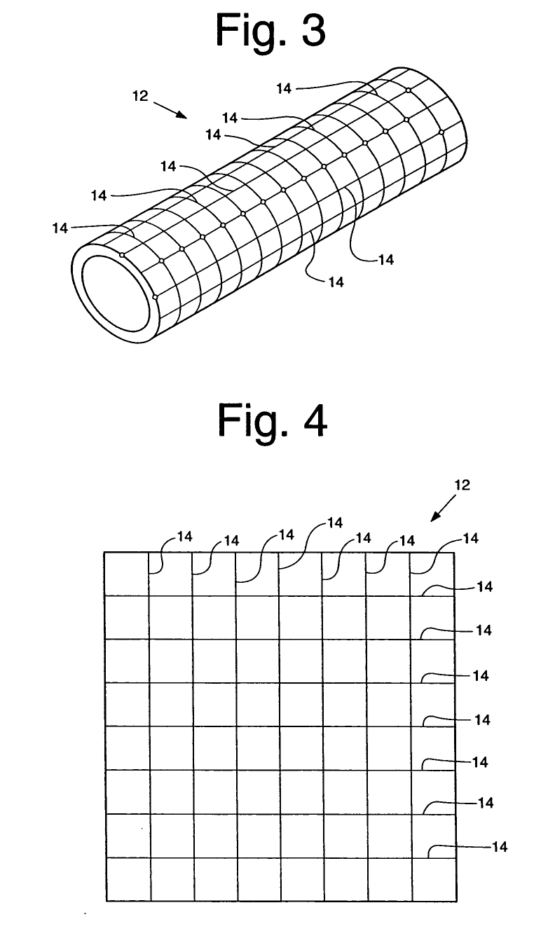

FIG. 3 illustrates a first embodiment of a matrix of the polymer layer 12 with the electroactive fiber 14. The matrix is in the shape of a tube like a blood vessel with several longitudinal and transverse fibers thereon.

FIG. 4 is an array of fibers 14 embedded within a polymer layer 12. In the depicted embodiment, the matrix has a square or rectangular shape. Such a structure may mimic the walls of large organs, skin or muscle walls.

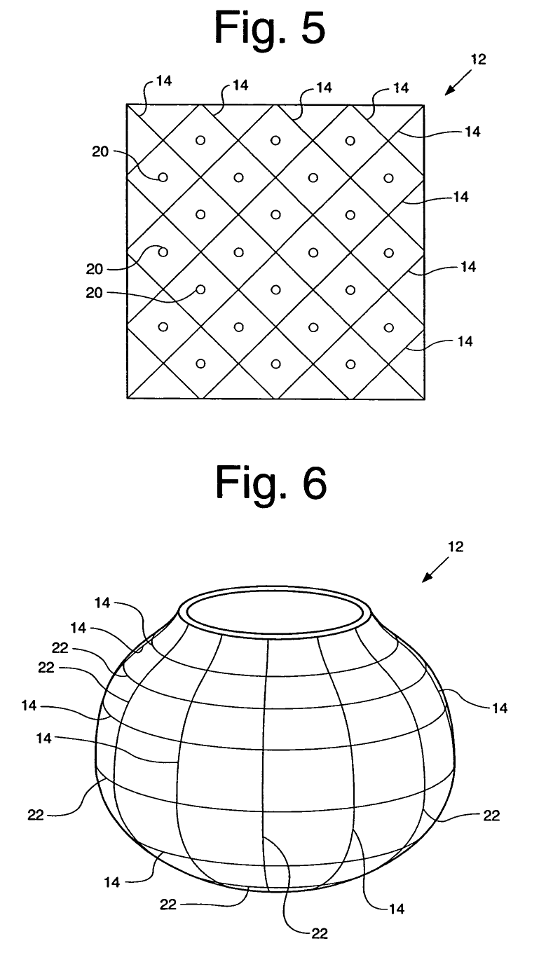

FIG. 5 depicts an array wherein activating fibers 14 are interspersed with sensors 20, either in alternating squares or in all squares as shown in FIG. 5, which may be attached to a separate circuit and provide feedback to a control system.

FIG. 6 is a third embodiment of the matrix with the array of FIG. 4 in a shape of a pouch or other closed or open shell, hollow or otherwise, that may mimic a human organ. The various combinations of the tube matrix, the square or rectangular array matrix or the bag may be used to simulate an entire human organ. The various matrixes may be assembled together in the MDS system 10 as shown in FIG. 1.

Control System

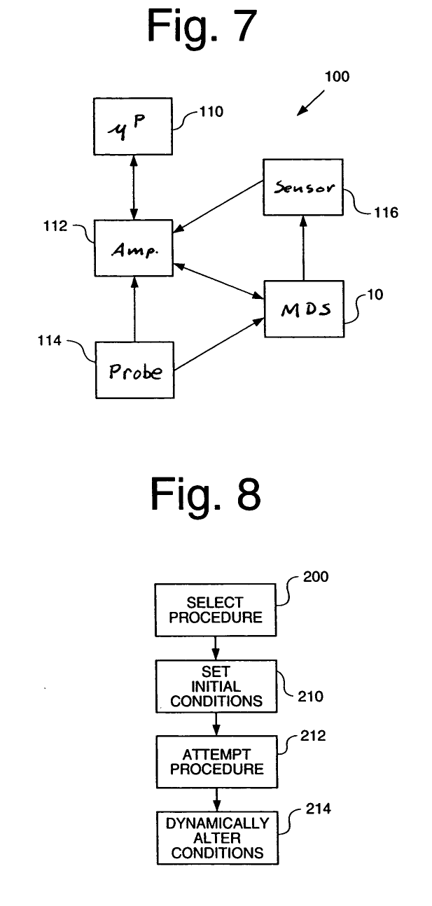

FIG. 7 illustrates a control system 100 for use in conjunction with the MDS system 10. The control system includes a computer having a microprocessor 110, an amplifier 112, a medical simulation device 114 such as a probe. The computer 110 is connected to the amplifier 112. The amplifier is connected to the MDS system 10, and specifically to the electrodes 13. The computer 110 sends a signal to the amplifier 112, which in turn sends a signal to the appropriate electrode to selectively activate or deactivate a specific electroactive fiber or group of fibers. The fibers' characteristics may be varied within a range by varying the potential within a corresponding voltage range. These ranges are in turn selected to correspond to the range of tension, ductility, elasticity, etc. of the particular live tissue being simulated.

The medical simulation device 114 is used to perform a procedure on the MDS system 10. The amplifier 112 receives a signal from the medical simulation device 114, amplifies it, and sends the amplified signal to the computer 110. The computer 110 interprets the signal and stores the data contained within the signal. Thereafter, the computer 110 can manipulate the data for various functions. For example, the computer may generate a graphical display indicating progress for the specified procedure. The computer may include a memory for storing settings and results.

Optionally, the control system 100 may include various sensors 116. As examples there may include a sensor 116 located on the probe 114 or on the electroactive fiber 14 or both. The sensor 116 may include a communications module and link such as an rf transmitter, for example a Bluetooth connection, a laser, an ultrasonic sensor, or other transducer. The sensors 116 are also connected to the amplifier 112. In this manner, the amplifier can process the signals received from the sensors 116 and send the processed signals to the computer 110.

Additionally, the probe 114 may include a camera or a telemetry system. As an example, the telemetry system may be a wireless system utilizing the Bluetooth standard. In that case, the amplifier 112 would have a wireless receiver to receive the wireless signals.

FIG. 8 depicts a flowchart for operation of a medical simulation device according to the present invention. First an instructor or tester selects a procedure 200. Selection is by a user interface such as a computer keyboard and screen. Having selected a procedure for simulation, the control system 100 sets initial conditions 210 in the physical components of the medical simulator 10. These may include activating EAP activation bands or fibers to mimic a physical malady such as a tumor, and/or may include activating sensors responsive to interaction of the simulator 10 with a medical student, as by palpation. Next, the medical student actually attempts the exam or procedure 212 such as an insertion of a device such as an IV needle. In response to the medical student performing a simulated examination or procedure, the system may dynamically alter the conditions 214 within the medical simulator 10. This may be by an examiner/instructor keying in alterations in the conditions of the activating or sensing elements, or it may occur automatically without action by an examiner/instructor and in direct response to a signal to the control system from a sensor having sensed human contact with the simulator 10.

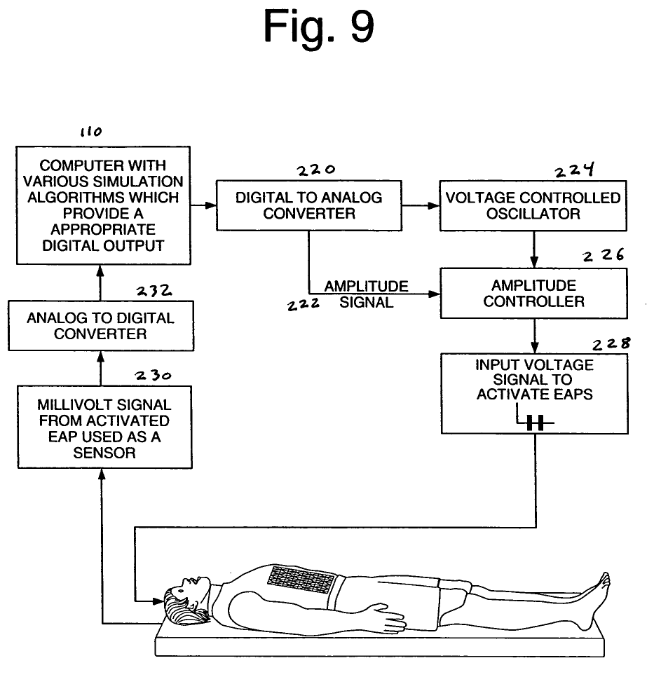

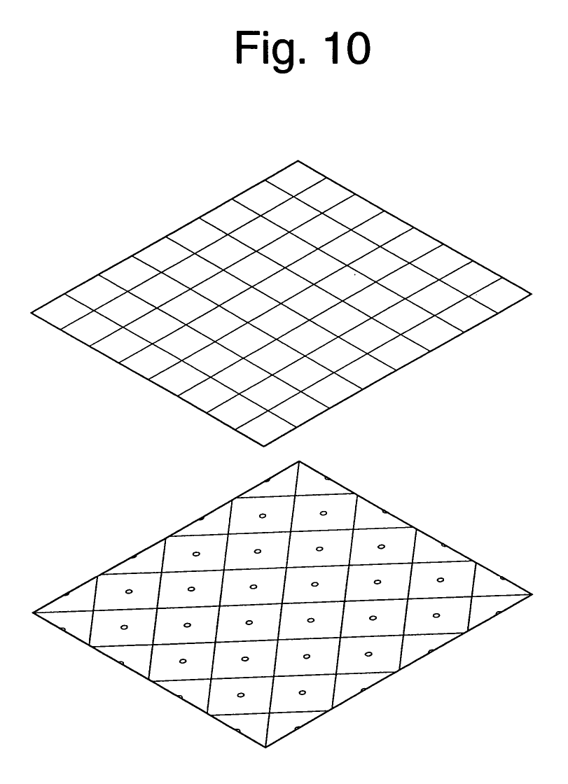

FIG. 9 is a block diagram of the electrical circuit components intermediate between the control system 100 and the human or animal simulator 10. The control system is embodied in hardware, software or firmware within the computer 110. It includes various algorithms for various simulations that output instructions in the form of signals to the particular appropriate components within the human or animal simulator 10. When a signal is sent from the computer processor 110 as controlled by the control system 100, such as setting initial conditions 210 or altering them 214, the actual electrical signal is first sent to a digital analog converter 220 in the depicted embodiment. The DAC 220 then directs an amplitude mediation signal 222 to be combined with the output of a voltage control oscillator 224 in order to deliver an amplitude control signal to amplitude controller 226. The amplitude controller 226 outputs an input voltage signal to activate the EAPs 228. As described elsewhere herein, the EAPs physically deform to a greater or lesser extent proportionally to the voltage potential across its circuit. Accordingly, a greater deformation is achieved by a higher input voltage and a more subtle deformation may be called up and signaled for by the control system 100 by effecting a lower input voltage, both of which are in turn initiated by a higher or lower input amplitude, as signaled.

When the human or animal simulator 10 is configured to include sensors in order to respond to touch, as for example by a human, including but not limited to medical students, the sensors, more fully described below, output a signal. In the depicted embodiment, when EAPs are used as sensors, typically the signal will be on the order of millivolts 230. An analog to digital converter 232 then sends the appropriate digital signal to the control system 100 within the computer processor 110. This may stimulate a display to a second participant in simulation, as for example a human, including but not limited to instructors or testing evaluators. Response to the received sensor signal may also include a second outgoing signal to the human or animal simulator 10 to dynamically alter conditions 214, with or without the input of a human mediator.

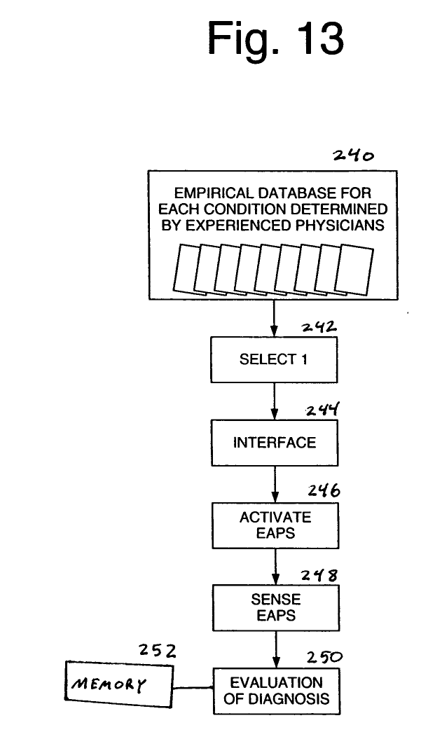

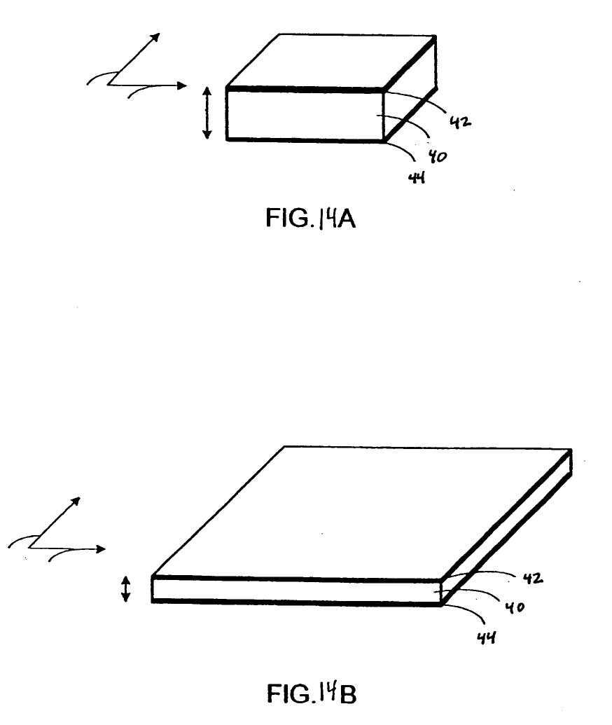

FIG. 13 depicts a flowchart for operation of the present invention when used as a medical simulator. Control system 100 includes an array of medical conditions to be simulated, as for example for physical examination by a medical student. The control system 100 includes a plurality of algorithms and data sets 240 for a plurality of medical conditions to be simulated. Some examinations that could be simulated according to the present invention include without limitation abdominal exams, pelvic exams, breast exams with palpation of simulated tumors or diseased livers, spleens, intestines or reproductive organs and the like. Procedures may also be simulated, especially procedures involving contact with an organ such as a vessel that reacts to the intervention. These may include without limitation, IV needle insertions, catheterizations, needle aspirations, biopsies or injections, interventional radiology, speculum exams, drain or tube insertions and angioplasties.

Each condition simulated will be correlated with an empirical database, the data being obtained from sensing a properly performed physical examination or procedure done by an experienced physician in order to gauge the pressure exerted and location of palpation or device insertion. This empirical database is used for each of the plurality of medical conditions simulated to signal to the components the proper corresponding conditions, including simulated organs activated, strength of activation, selectivity of individual EAP fibers, bands or strips activated and the like. The empirical database may also include responsiveness settings for sensors corresponding to greater or lesser degrees of sensitivity in appropriate physical locations for patients having the malady being simulated.

The control system 100 is used to control the fibers 14 to mimic human tissue. The aforesaid characteristics of the electroactive fibers, tension, elasticity, ductility, etc., are analogous to the same characteristics for the live tissue being simulated due to the careful selection and construction of the particular electroactive material, its thickness, space between electrodes, the pattern of the array and the bonding with surrounding latex or other material. The control system 100 sets the upper and lower ranges of voltages for particular pairs or arrays of electrodes such that the electroactive fibers they control correspond to a known database of the same characteristics in human tissue. The known data base of human tissue may be established empirically. If that is the case, the fibers may be initially calibrated by someone skilled in the medical field so that they have the appropriate touch and feel to the appropriate human tissue. The control system 100, via the computer 110, either increases or decreases the tension or the modulus of elasticity of the electroactive fibers 14 to correspond to the specified human tissue. For example, if the electroactive fiber 14 is located in a simulated vein or artery in the MDS system 10, the control system 100 will adjust the various segments or sections of the fibers 14 to either shape or restrict the diameter of the vein, or loosen it, shorten it, or the like.

The control system 100 performs certain steps in controlling the fibers 14 and the MDS system 10. In a first step 200, a procedure is selected from a list of procedures stored in the computer. For example, an instructor could select a vascular surgery, a colonoscopy or thoracic surgery. In the depicted embodiment, a vascular surgery is selected such as installing a stent in the heart. After the procedure is selected, the control system 100 sets the initial conditions in a second step 210. For example, the control system 100 may set the person's type, such as an older person or younger person and may also optionally specific a defect. In the given example of vascular surgery, the control system 100 may select a defect of collapsing or binding the vein such that a probe will not proceed properly. Thereafter, a student attempts the procedure in a third step 212. In some embodiments, the conditions of the MDS system may be changed dynamically while the student is performing the procedure in an optional step 214. This dynamic change may be based on instructor input, based upon a computer program within the control system or based upon sensor readings. In that case, the teaching method of teaching a student a certain procedure may be manual or automated and in the manual case the instructor adjusts the MDS system via the control system to teach the student a certain aspect of the procedure. In contrast in the automatic system, the program of the control system will automatically adjust the conditions and leave it to the student to identify and solve the given problem.

In operation, a tester or operator selects one 242 of the variety of medical conditions to be simulated 240, through a user interface 244. Having selected a condition to simulate, the control system 100 activates the EAPs to assume their proper initial conditions 246. After a human medical student, for example, interacts with the human or animal simulator 10, the sensory EAPs (or other sensors) return their signals 248 to the control system 100. They may indicate where and with what pressure the physical exam or device application was performed. At final step 250 the diagnosis from the physical exam is evaluated. This may include both the objective input by a student tested or evaluator entering the answer to the question indicating whether or not the correct diagnosis was achieved. Evaluation step 250 may also include any objective numerical or graphic readout of the sensed physical exam, indicating proper locations examined, improper locations examined and degree of pressure exerted. Evaluations may be stored in memory 252.

Materials

Candidate EAPs include, but are not limited to, electronic electroactive polymers and ionic electroactive polymers.

Potential Electronic EAPs are Ferroelectric Polymers, Dielectric EAP, Electrostrictive Graft Elastomers, Electrostrictive Paper, Electroviscoelastic Elastomers, and Liquid-Crystal Elastomer (LCE) Materials.

Potential Ionic EAPs are Ionic Polymer Gels (IPG), Ionomeric Polymer-Metal Composites (IPMC), Conductive Polymers (CP), Carbon Nanotubes (CNT), and Electroheological Fluids (ERF).

Materials that could be used as a substrate that simulates skin include but are not limited to the following:

1. A-101—6382 Prosthetic Silicone Elastomer

2. A-i 06—2370 Low Density Silicone Elastomer

3. FX-i08 and FX-iO8T—Tinsil Silicone Elastomer

4. A-103—MDX4-4210 Medical Grade Elastomer

5. A-100—Type A Medical Adhesive

6. A-103—MDX4-4210 Medical Grade Elastomer

7. LSR-4305/V50093—LSR Silicone Elastomer (A-221-05)

8. LSR-4330/V50131—LSR Silicone Elastomer (A-223-30)

9. LSR-4350/50096—LSR Silicone Elastomer (A-223-40)

10. LSR-43501V5 0097—LSR Silicone Elastomer (A-225-50)

11. LSR-4360/V50 102 LSR Silicone Elastomer (A-225-60)

12. LSR-4370/V50 101—LSR Silicone Elastomer (A-225-70)

13. A-2000—Platinum Silicone Elastomer

14. A-2 186 and A-2186-F—Platinum Silicone Elastomer

15. A-221-05—LSR Silicone Elastomer (Rhodia LSR-4305/V50093)

16. A-223-30—LSR Silicone Elastomer (Rhodia LSR-4330/V501 31)

17. A-223-40—LSR Silicone Elastomér (Rhodia LSR-4340/V50096)

18. A-225-50—LSR Silicone Elastomer (Rhodia LSR-4350/V50097)

19. A-225-60—LSR Silicone Elastomer (Rhodia LSR-43601V50 102)

20. A-RTV-30—Platinum Silicone

21. LSR-05—Silicone Elastomer

22. VST-30—VerSilTal Silicone Elastomer

23. VST-50—VerSilTal Silicone Elastomer

24. VST-50F—VerSilTal Silicone Elastomer

Materials suitable for use as a pre-strained polymer with the present invention may include any substantially insulating polymer or rubber (or combination thereof) that deforms in response to an electrostatic force or whose deformation results in a change in electric field. One suitable material is NuSil CF19-2186 as provided by NuSil Technology of Carpenteria, Calif. More generally, exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example. Obviously, combinations of some of these materials may be used as the polymer in transducers of this invention.

One example of a suitable silicone elastomer is Dow Corning HS3 as provided by Dow Corning of Wilmington, Del. One example of a suitable fluorosilicone is Dow Corning 730 as provided by Dow Corning of Wilmington, Del. One suitable example of a thermoplastic elastomer is styrene butadiene styrene (SBS) block copolymer.

Some acrylics such as any acrylic in the 4900 VHB acrylic series as provided by 3M Corp. of St. Paul, Minn. have properties suitable for this invention. Thus, in some embodiments, polymers suitable for use with the present invention may be made from any monoethylenically unsaturated monomer (or combination of monomers) homopolymerizable to form a polymer having a glass transition temperature at most about 0 degrees Celsius. Preferred monoethylenically unsaturated monomers include isooctyl acrylate, 2-ethylhexyl acrylate, decyl acrylate, dodecyl acrylate, hexyl acrylate, isononyl acrylate, isooctyl methacrylate, and 2-ethylhexyl methacrylate. Any of the monomers may also include one or more halogens such as fluorine.

One example of a suitable copolymer includes both silicone and acrylic elastomer moieties. In some case, materials suitable for use with the present invention may contain combinations of one or more of the above listed materials. For example, one suitable polymer is a blend including a silicone elastomer and an acrylic elastomer.

In many cases, materials used in accordance with the present invention are commercially available polymers. The commercially available polymers may include, for example, any commercially available silicone elastomer, polyurethane, PVDF copolymer and adhesive elastomer.

Electroactive polymers of the present invention may also include one or more additives to improve various properties. Examples of suitable classes of materials include plasticizers, antioxidants, and high dielectric constant particulates. Examples of suitable plasticizers include high molecular-weight hydrocarbon oils, high molecular-weight hydrocarbon greases, Pentalyne H, Piccovar.RTM. AP Hydrocarbon Resins, Admex 760, Plastolein 9720, silicone oils, silicone greases, Floral 105, silicone elastomers, nonionic surfactants, and the like. Of course, combinations of these materials may be used. In one embodiment, the antioxidant is a nonvolatile solid antioxidant.

In one embodiment, the additives improve the ability of the polymer to convert between mechanical energy and electrical energy. Generally, the additive may improve any polymer property or parameter related to the ability of the parameter to convert between mechanical energy and electrical energy. Polymer material properties and parameters related to the ability of the polymer to convert between mechanical energy and electrical energy include, for example, the dielectric breakdown strength, maximum strain, dielectric constant, elastic modulus, properties associated with the visco-elastic performance, properties associated with creep, response time and actuation voltage. The addition of a plasticizer may, for example, improve the functioning of a transducer of this invention by reducing the elastic modulus of the polymer and/or increasing the dielectric breakdown strength of the polymer.

In one embodiment, an additive is included in a polymer to improve the dielectric breakdown strength of the polymer. Improving the dielectric breakdown strength allows the use of larger electrically actuated strains for the polymer. By way of example, a plasticizing additive may be added to a polymer to increase the dielectric breakdown strength of the polymer. Alternatively, a synthetic resin may be added to a styrene-butadiene-styrene block copolymer to improve the dialectic breakdown strength of the copolymer. For example, pentalyn-H as produced by Hercules, Inc. of Wilmington, Del. was added to Kraton D2104 as produced by Shell Chemical of Houston, Tex. to improve the dialectic breakdown strength of the Kraton D2104. Further detail on the fabrication of polymers including addition of one or more additives is provided below. In this case, the ratio of pentalyn-H added may range from about 0 to 2:1 by weight. In another embodiment, an additive is included to increase the dielectric constant of a polymer. For example, high dielectric constant particulates such as fine ceramic powders may be added to increase the dielectric constant of a commercially available polymer. Alternatively, polymers such as polyurethane may be partially fluorinated to increase the dielectric constant.

Alternatively, an additive may be included in a polymer to reduce the elastic modulus of the polymer. Reducing the elastic modulus enables larger strains for the polymer. In a specific embodiment, mineral oil was added to a solution of Kraton D to reduce the elastic modulus of the polymer. In this case, the ratio of mineral oil added may range from about 0 to 2:1 by weight. Specific materials included to reduce the elastic modulus of an acrylic polymer of the present invention include any acrylic acids, acrylic adhesives, acrylics including flexible side groups such as isooctyl groups and 2-ethylhexyl groups, or any copolymer of acrylic acid and isooctyl acrylate.

Multiple additives may be included in a polymer to improve performance of one or more material properties. In one embodiment, mineral oil and pentalyn-H were both added to a solution of Kraton D2104 to increase the dielectric breakdown strength and to reduce the elastic modulus of the polymer. Alternatively, for a commercially available silicone rubber whose stiffness has been increased by fine carbon particles used to increase the dielectric constant, the stiffness may be reduced by the addition of a carbon or silver filled silicone grease.

An additive may also be included in a polymer to provide an additional properties. The additional property is not necessarily associated with polymer performance in converting between mechanical and electrical energy. By way of example, pentalyn-H may be added to Kraton D2104 to provide an adhesive property to the polymer. In this case, the additive also aids in conversion between mechanical and electrical energy. In a specific embodiment, polymers comprising Kraton D2104, pentalyn-H, mineral oil and fabricated using butyl acetate provided an adhesive polymer and a maximum linear strain in the range of about 70 to 200 percent.

Depending on the combination of EAP and substrate, the EAP may or may not be bonded to the substrate. There are many bonding agents available for the substrate.

It is worthy of note that some EAPs require a high humidity environment; thus, the area of the EAP in the substrate may include addition of chemical stimulants.

It is within the scope of the present invention to use any EAPs including without limitation those listed above. It is also within the scope of the present invention to structure the EAPs in any configuration, including without limitation the type of helical electrode structures disclosed in U.S. Patent Application 2005/0006989 A1 to Wallace.

Simulator Configuration

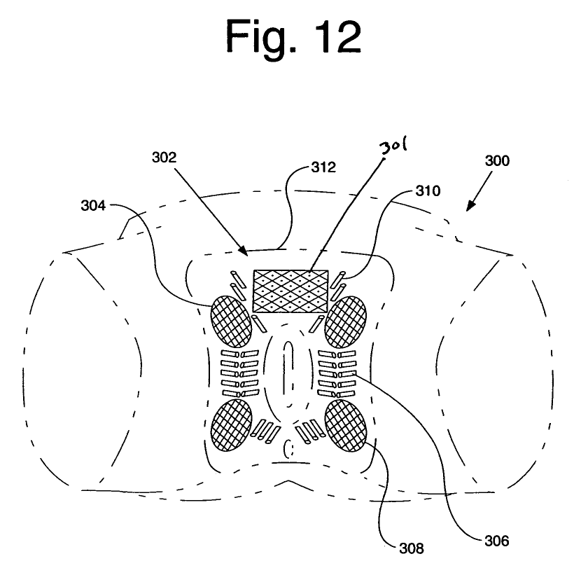

In FIG. 12 a medical simulator according to the present invention is depicted. Any moving and responsive thing, chiefly animals, may be simulated according to the present invention, including imaginary animals. The depicted embodiment simulates a human being. It is a simulator of a human's pelvis. A pelvis simulator 300 such as depicted in FIG. 12, would include a hollow cavity analogous to the peritoneal cavity 302 containing electroactive polymers, with or without additional substrates, constructed and arranged to mimic various human organs. Outside the cavity 302 layers of material may be arranged, including but not limited to those disclosed in U.S. Pat. No. 6,780,016 B1, incorporated by reference herein, disclosing multiple layers of various different polymers and materials.

For individual organs, a series of EAP fibers or EAP bands may be woven into a sphere or tube such as indicated at 304, which is placed in a position where an organ to be taught or tested is typically found, such as an appendix. Hollow simulated organs may contain fluid, and the control system may be programmed to cycle flexion of the EAPs, as for example to simulate a pulse.

Other electroactive polymers may be short bands or strips mounted on a post. Upon application of a potential, these strips flex either up or down. A series of such strips such as indicated at 306 may be arranged in a column. One series of strips 306 depicted in FIG. 12 may be located in a position corresponding to a human descending large colon. Further electroactive polymers may be placed at location analogous to where a human uterus would be found and analogous to the position of the human adnexa 310. Further organs may be imitated.

One advantageous function of the medical simulator would be mimicking tumors. Tumors typically are more hard or dense than the surrounding tissue. Accordingly, in operation, electroactive polymers arranged such as at 306 or 308 may have a voltage applied in order to flex into a position of greater hardness. This harder density may be palpated by a medical student in order to learn the feeling of such a tumor for diagnostic purposes. A sphere or pouch of woven electroactive polymer fibers or bands 308, will contract or flex inward when activated. Due to the woven nature of them, this causes them to become more dense and firm, which in turn may be felt by the medical student. In the case of 306, the electroactive polymer strips may flex upward, as seen in FIG. 12, or more generally outward in order to provide a denser or more hard feeling to a medical student, again analogous to the tumor such as would be diagnostic of colon cancer. A series of electroactive polymers may be constructed and arranged as at 306 in order that a variable number of strips may be activated, thereby making the simulator diagnosis easier or more difficult. In either case, the electroactive polymers, either as strips, woven strips or fibers, may be embedded in an independent substrate or woven around one, in order to give them a continuous and differentiated feel to the medical student's palpation through the overlying substrate 312 that would be analogous to a muscle wall of the abdomen. Finally, activating selected strips in an array 306 or selected fibers or bands in a woven pouch 304, 308 may produce a feel that is more or less diffuse, or well differentiated, thereby simulating different types of tumors. An array 301 with activating (deflecting) EAP fibers and/or sensors may simulate a muscle wall or overlay.

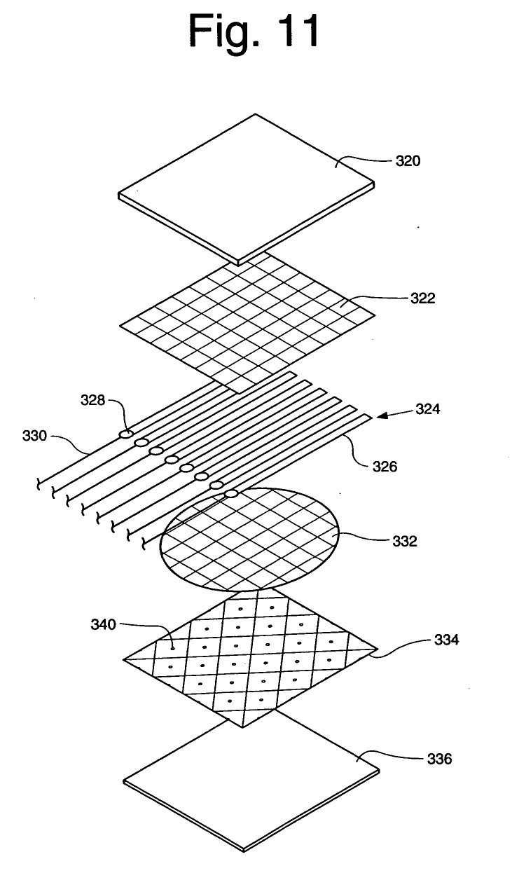

In FIG. 11 is depicted a cross section of a more complex medical simulator. FIG. 11 depicts a layer of materials such as latex 320 which is analogous to skin. Immediately beneath the skin is a woven array 322 of electroactive polymers located in a position that would be analogous to a muscle wall. In the space beneath the muscle wall array 322 are any combination or variety of electroactive polymer simulated organs such as described herein, including strips 324, woven pouches or spheres. In the case of electroactive polymer band assemblies, each may be comprised of the electroactive polymer itself 326 and an anchor 328 on which it is mounted. Multiple simulated organs may be layered 332. Each simulated organ is wired into a circuit 330, such as shown at assembly 324. Underneath each of these subassemblies analogous to organs may be a second array of woven electroactive fibers 334. Under array 334 and supported with all of the components above it is a base 336.

In operation then, an instructor or operator on the medical simulator activates a particular array or structure of electroactive polymers by applying a potential to it through a control interface in order that the electroactive polymer structure physically moves or flexes into a position that may be felt by a medical student and simulate a diagnostic clinical sign.

Sensor Response

Advantageously, the medical simulator will respond to the direct touch of the medical student in addition to a controlled operation by an instructor. Accordingly, the present invention provides for sensors 340 to be incorporated in the medical simulator alongside the active electroactive polymers. Sensors are in operative communication with EAPs for activation by deflection. A sensor circuit may be separate from an activation circuit, or it may be the same circuit.

The sensors 340 may be of any pressure sensitive type, including without limitation piezoelectric cells or the electroactive polymers themselves, in the depicted embodiment. The sensors may include without limitation those disclosed in U.S. Pat. No. 6,809,462 to Pelrine. The sensors may be advantageously arranged in between the fibers of an array, such as depicted in FIG. 5 at numbers 20 or numbers 340 in array 334 in FIG. 11. EAPs may be used as sensor fibers in alternating positions with activating EAP fibers, such as alternating sensor fibers 22 and activating fibers 14 by position in FIG. 6. Sensing and activating fibers may be wired to different circuits.

In a more complex arrangement, the lower array may be wired to act as a sensor. This array may be a series of conventional pressure sensors, piezoelectric sensors, or electroactive polymers. When used as a sensor, the electroactive polymer is wired to a potential source but no current is applied. When mechanically deformed by pressure, as by the hand of a medical student during palpation, the deformation of the electroactive polymer generates a current that may be sensed by the circuit. In the embodiment depicted on FIG. 11, the lower sensor array 334 is a separate circuit from any electroactive polymer activating circuit.

In operation then, if a student is palpating the abdomen of the medical simulator such as depicted in FIG. 11 and presses hard enough to hurt a live patient, the sensor circuit 334 is preconfigured to respond to that degree of pressure and signal the instructor and/or student that the pressure is too great. The pressure sufficient to diagnostically palpate a simulated tumor and to elicit a likely patient response to pressure may be manipulated in program preconfiguration such that various combinations of likely patient responses may mimic various diseases. In other words, some disease conditions cannot be properly diagnosed without causing some discomfort to the patient, and the medical simulator can be programmed to signal pain before enough pressure is exerted to feel a simulated disease condition such as a tumor.

It is within the scope of the present invention that the same circuit and electroactive polymer structure used to activate or flex in order to mimic a disease condition may also act as a sensor in a neutral state. That is, when a voltage potential is applied to the circuit by an instructor, the electroactive polymers activate or flex and assume the dense hard configuration analogous to a disease condition such as a tumor. However, when not so activated by application of a potential, the circuit may receive a current generated by deformation of the same electroactive polymer in order to signal that pressure is being exerted on it. Accordingly, the same structure, such as 324 or 332 in FIG. 11 or 304 or 306 in FIG. 12 may in one instructive session be activated to assume a dense configuration and mimic a tumor and, in a separate session or cycle, may be left in a neutral or receptive state as a sensor in order to mimic an organ that is sensitive in a diseased state, such as an inflamed appendix.

It is also within the scope of the present invention that the same circuit and electroactive polymer structure used to activate or flex in order to mimic a disease condition may also act as a sensor in the activated or flexed state. The voltage potential is applied to the circuit by an instructor, and the electroactive polymers activate or flex and assume the displaced configuration analogous to a disease condition such as a tumor. When so activated by application of a potential, the circuit retains its electric properties, including alterability of current flow, capacitance and resistance between the electrodes. By monitoring changes in any of these properties or others that are caused when pressure from an exam further deforms the EAP layer between the electrodes, a signal current may be generated in order to signal that pressure is being exerted. Such a sensor is depicted in FIG. 15 at 58. Accordingly, the same structure, such as 324 or 332 in FIG. 11 or 304 or 306 in FIG. 12 may in one instructive session be activated to assume a displaced configuration and mimic a tumor and, in the same session, may be left in a neutral or receptive state as a sensor in order to mimic an organ that is sensitive in a diseased state, such as an inflamed appendix.

Upper array 322 in FIG. 11 may be activated to become increasingly tense or rigid in order to simulate different states of muscle wall. If the simulator is simulating a young athletic person, the upper array may be flexed to increase the amount of pressure that must be applied to diagnose simulated disease conditions underneath. In the case of an elderly or a weak patient, the array may be relaxed. Similarly, the upper array may be put in a neutral state to act as a sensor. Accordingly, an infected peritoneum may be simulated wherein even the initial touch of the abdominal wall elicits a pain response from the patient.

FIG. 16 depicts an array of EAPs disposed to simulated muscle. Long thin EAP structures, for example fibers 70, are arranged in parallel. Each may be on a circuit 72. Sensors 74 may be interspersed among the activation fibers and wired separately, or the activating EAP fibers 70 may be used as sensors, either alternating by position, by actuation cycle or simultaneously, as described above.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to particular uses contemplated including but not limited to medical simulators, animal simulators, entertainment devices, or animatronic devices. The description of the invention is merely exemplary in nature and, thus, variations that do not depart from the gist of the invention are intended to be within the scope of the invention. Such variations are not to be regarded as a departure from the spirit and scope of the invention.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An animal simulator being constructed and arranged to mimic selected anatomy, said animal simulator comprising:
a substrate;
an electroactive polymer assembly, said electroactive polymer assembly being within said substrate, said electroactive polymer assembly being comprised of at least one electroactive polymer and at least one electrode;
at least one circuit, said circuit being in operative communication with said electrode such that said electroactive polymer assembly deflects upon receipt of a signal through said circuit, said deflection simulating said anatomy.

2. The simulator of claim 1 wherein said animal simulator is a human simulator.

3. The simulator of claim 1 wherein said simulated anatomy is simulated to be pathological.

4. The simulator of claim 1 wherein said signal is initiated by a human operator through an operator interface, said operator interface being in operative communication with said circuit.

5. The animal simulator of claim 1 further comprising a sensor, said sensor being within said animal simulator and said sensor being in operative communication with said circuit.

6. The animal simulator of claim 5 wherein said sensor is further in operative communication with a control system, said control system being embodied in a computer processor.

7. The animal simulator of claim 5 wherein said sensor is in operative communication with an operator interface, said operative communication with said operator interface including a display of any engagement of said sensor and including further providing a control of said sensor through said operator interface.

8. The animal simulator of claim 5 wherein said sensor is an electroactive polymer assembly.

9. The animal simulator of claim 5 wherein said sensor is on a second circuit, said second circuit being separate from said circuit in operative communication with said deflecting electroactive polymer assemblies.

10. The animal simulator of claim 8 wherein said electroactive polymer assembly sensor is on the same circuit as said circuit in operative communication with said deflecting electroactive polymer assembly, said electroactive polymer sensor being enabled to sense when said circuit is in a first state and said deflecting electroactive polymer being enabled to deflect when said circuit is in a second state.

11. The animal simulator of claim 1 wherein said deflecting electroactive polymer assembly is enabled to sense pressure when not deflected.

12. The animal simulator of claim 1 wherein said electroactive polymer is enabled to sense pressure when it is deflected.

13. The animal simulator of claim 5 wherein said sensor is pressure sensitive.

14. The animal simulator of claim 5 wherein said signal is automatically generated by said sensor.

15. The animal simulator of claim 1 further comprising a plurality of electroactive polymer assemblies.

16. The animal simulator of claim 1 wherein said substrate at least partially circumscribes a cavity, said electroactive polymer assembly being substantially within said cavity.

17. The animal simulator of claim 1 wherein said electroactive polymer assembly is embedded within a solid substrate.

18. The animal simulator of claim 1 wherein said electroactive polymer is selected from the group consisting of: A-101—6382 Prosthetic Silicone Elastomer, A-i 06—2370 Low Density Silicone Elastomer, FX-i08 and FX-iO8T—Tinsil Silicone Elastomer, A-103—MDX4-4210 Medical Grade Elastomer, A-100—Type A Medical Adhesive, A-103—MDX4-4210 Medical Grade Elastomer, LSR-4305/V50093—LSR Silicone Elastomer (A-221-05), LSR-4330/V50131—LSR Silicone Elastomer (A-223-30), LSR-4350/V50096—LSR Silicone Elastomer (A-223-40), LSR-43501V5 0097—LSR Silicone Elastomer (A-225-50), LSR-4360/V50 102 LSR Silicone Elastomer (A-225-60), LSR-4370/50 101—LSR Silicone Elastomer (A-225-70), A-2000—Platinum Silicone Elastomer, A-2 186 and A-2186-F—Platinum Silicone Elastomer, A-221-05—LSR Silicone Elastomer (Rhodia LSR-4305/V50093), A-223-30—LSR Silicone Elastomer (Rhodia LSR-4330/V501 31), A-223-40—LSR Silicone Elastomér (Rhodia LSR-4340/V50096), A-225-50—LSR Silicone Elastomer (Rhodia LSR-4350/V50097), A-225-60—LSR Silicone Elastomer (Rhodia LSR-43601V50 102), A-RTV-30—Platinum Silicone, LSR-05—Silicone Elastomer, VST-30—VerSilTal Silicone Elastomer, VST-50—VerSilTal Silicone Elastomer, and VST-50F—VerSilTal Silicone Elastomer.

19. The animal simulator of claim 1 further comprising said electroactive polymer assembly being constructed and arranged to simulate an individual organ.

20. The animal simulator of claim 19 wherein said electroactive polymer assembly assembled to simulate an individual organ includes at least one sensor, said sensor being in operative communication with a sensor circuit and said sensor circuit being in operative communication with said circuit for deflecting said electroactive polymer assembly.

21. The animal simulator of claim 19 wherein said electroactive polymer assembly is constructed and arranged to be substantially hollow.

22. The animal simulator of claim 21 wherein said hollow assembly contains fluid.

23. The animal simulator of claim 1 further comprising a control system, said control system being in operative communication with said electroactive polymer assembly through said circuit, said circuit being an activation circuit.

24. The animal simulator of claim 23 wherein said control system is controlled by an operator through an operator interface.

25. The animal simulator of claim 23 wherein said control system comprises at least one algorithm said algorithm corresponding to a disease condition, and said algorithm including a signal to said electroactive polymer such that upon selection of said algorithm, said algorithm sets said electroactive polymer assembly in an initial condition.

26. The animal simulator of claim 25 wherein said algorithm modifies said electroactive polymer from said initial condition to a second condition, said modification being in response to an instruction to modify.

27. The animal simulator of claim 26 wherein said instruction to modify is received from an operator through an operator interface.

28. The animal simulator of claim 26 wherein said instruction to modify is received from a sensor, said sensor being within said animal simulator and said sensor being in operative communication with said control system.

29. The animal simulator of claim 23 further comprising a memory in operative communication with said control system.

30. The animal simulator of claim 1 further comprising a probe.
